(19) United States
(12) Patent Application Publication
(10) Pub. No.: US 2011/0111203 A1
(43) Pub. Date: May 12, 2011

(54) SUBSTRATE WITH A SOL-GEL LAYER AND METHOD FOR PRODUCING A COMPOSITE MATERIAL

(76) Inventors: Gabriele Roemer-Scheuermann, Ingelheim (DE); Gerhard Weber, Bechenheim (DE); Joerg Schuhmacher, Kornwestheim (DE); Stefan Bauer, Alzey (DE); Harry Engelmann, Ingelheim (DE); Marta Krzyzak, Alfeld (DE); Irmgard Westenberger, Mainz (DE); Peter Zachmann, Osthofen (DE)

(21) Appl. No.: 12/746,477

(22) PCT Filed: Dec. 5, 2008
(86) PCT No.: PCT/EP08/10349

§ 371 Date: Nov. 29, 2010

(30) Foreign Application Priority Data
Dec. 5, 2007 (DE) 10 2007 058 926.5
Dec. 5, 2007 (DE) 10 2007 058 927.3

(51) Int. Cl. B32B 17/06; B05D 5/06; G02B 1/11; C03C 17/34; B32B 5/18; B32B 7/00

(52) U.S. Cl. 428/312.6; 427/165; 428/312.8; 428/319.1; 428/323; 428/336; 428/426; 428/428; 428/450

(57) ABSTRACT

A substrate with a sol-gel layer and to a method for producing a composite material wherein a barrier layer is placed between the sol-gel layer and the substrate are provided.

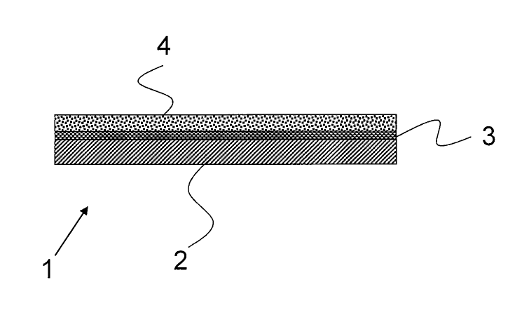

### CROSS REFERENCE TO RELATED APPLICATIONS

This application is a U.S. National Stage Entry under 35 U.S.C. §371 of International Application No. PCT/EP2008/010349 filed on Dec. 5, 2008, which claims the benefit of German Application No. 10 2007 058 926.5 filed on Dec. 5, 2007 and German Application No. 10 2007 058 927.3 filed on Dec. 5, 2007.

### BACKGROUND OF THE INVENTION

1. Field of the Invention

The invention relates to a substrate with a sol-gel-layer, to a composite material, and to a method for producing a composite material. In particular the invention relates to a glass substrate having a porous single layered anti reflection coating.

2. Description of Related Art

Especially in solar industries, glass as a transparent material plays an important role. The different refractive indices of air and glass, however, cause losses in light yield at the glass-air interface due to reflections. It is known to increase light yield by a surface treatment of the glass. Such surface treatment techniques include in particular etching and coating of the glass, as an anti-reflection treatment of the glass. Since etching mostly implies the use of dangerous substances such as HF, anti-reflection coatings are preferred as an anti-reflection treatment.

In this context it is important to provide a broadband anti-reflection effect over a range of the solar spectrum as large as possible. Furthermore, the anti-reflection coating should be efficient for varying angles of incidence that result from the changing position of the sun. It is known that this can in particular be obtained by single layered anti-reflection coatings.

Anti-reflection layers based on silicon oxide are preferably used. Such layers which are produced for example by sputtering, PECVD, or by a sol-gel method, however, have a refractive index of about 1.46 when applied as dense layers, and are in this form not suitable as an anti-reflection coating, especially for soda-lime glass poor in iron which is used as a cover glass for photovoltaic applications.

An optimal anti-reflection coating should have a refractive index of about 1.22. Such a low refractive index cannot be obtained with conventional dense coating material, rather, to this end porous layers have to be applied, or have to be produced by post-processing steps, such as described in German disclosure DE 102005007825, where mixing of coating material and air occurs thereby lowering the effective refractive index of the coating material. Such a coating is suitably produced by a sol-gel method. Also, liquid coating provides a cost efficient way for coating large substrates.

Such porous coatings can be produced in different ways. For example, it is known to produce a porous coating by means of particular, aqueous, or alcoholic SiO₂ sols. However, those layers often exhibit poor mechanical resistance, in particular poor abrasion resistance.

Modifications of this approach comprise various methods for optimizing abrasion resistance, e.g. the use of a particular inorganic-organic hydride sol such as described in DE 19918811; optimization of firing conditions such as described in DE 19828231; or the use of two different grain size fractions such as described in U.S. Pat. No. 0,258,929. The disclosure of the above documents with the character described above is incorporated herein by reference.

In U.S. Pat. No. 0,258,929 and DE 10051724 a porous sol-gel layer is described that is fired during thermal pre-stressing, which is performed to particularly increase the hardness of the layer. The disclosure of these documents is also incorporated herein by reference.

Tests of porous sol-gel layers on borosilicate glass have shown that the abrasion resistance of these coatings is probably yet worse than on soda-lime glass (see e.g. Proceedings of SPIE—The International Society for Optical Engineering (1989), 1038 (Meet. Isr. Opt. Eng., 6th, 1988), 326-36, or Eur. J. Glass Sci. Technol. A, October 2006 (47), 153-156).

Attempts to obtain a good abrasion resistance even on borosilicate glass include on one hand a supplementary dipping step into a sodium solution to harden the layer, or addition of for example phosphor to promote sodium diffusion. Besides from enhancement of both abrasion resistance and refractive index, sodium also plays a role with regard to the aging of the layers. Examination of aging is of special importance for these single layered anti-reflection coatings, since in solar industries long warranties of 20 years and more are common practice. As examinations of presently marketed single layered anti-reflection coatings on the base of porous SiO₂ layers have shown, these layers exhibit only very poor resistance under stress conditions which are relevant for solar modules, such as the damp heat test (85° C., 85% rel. humidity) in accordance with DIN 61215. Here, only after a short time, often already after a few days, haze occurs, and thereby a loss in transmittance.

### BRIEF SUMMARY OF THE INVENTION

An object of the invention, therefore, is to at least mitigate the disadvantages of the prior art mentioned above.

In particular, it is an object of the invention to provide an abrasion resistant, environmental stable composite material and/or an abrasion resistant and at the same time environmental stable porous SiO₂ coating with a good anti-reflection effect, and good enhancement of transmittance in a range of wavelengths relevant for a solar cell.

This object of the invention is already achieved by a substrate, a composite material, and a method for producing a composite material.

The invention relates to a substrate with at least one sol-gel layer, and with at least one barrier layer. The barrier layer is placed between the at least one sol-gel layer and the substrate.

Surprisingly, it has been found that a barrier layer which is placed below the sol-gel layer considerably enhances environmental stability of the composite material so produced. In particular, blooming and haze of the glass can be prevented almost entirely over a long time.

A barrier layer in the sense of the invention is a layer which reduces diffusion, in particular that of sodium and/or water. Preferably, the diffusion of sodium and/or water is reduced by at least 30%, more preferably by 80%.

Besides a barrier layer in the classical sense, barrier layers in the sense of the present invention are for example also layers poor in sodium due to leaching, or layers exhibiting a gettering effect for sodium.

In particular, it is also contemplated to produce the barrier layer by leaching of the substrate, for example to remove alkali metals near the surface of the substrate by an etching technique. It is now supposed that the blooming effect in known composite materials having a single layered anti-reflection coating is primarily not due to a destruction of the anti-reflection layer, but that glass corrosion of the substrate glass below the anti-reflection layer causes this haze and blooming in the glass.

Hence, a barrier layer can also be understood as an anti-corrosive layer which prevents glass corrosion of the substrate glass.

A glass substrate is preferably used as a substrate, in particular a soda-lime glass preferably poor in iron.

The barrier layer preferably comprises a metal oxide or a semi-metal oxide. In particular, a barrier layer is provided which substantially comprises silicon oxide. Alternatively, titanium oxide or tin oxide is contemplated as well.

The barrier layer is preferably formed as thin as not to be optically active. Thicknesses from 3 to 100 nm, preferably from 5 to 50 nm, and more preferably from 10 to 35 nm have been proved as advantageous.

In a preferred embodiment of the invention the sol-gel layer comprises nanoparticles, in particular glass nanoparticles. Preferably, nanoparticles are used which substantially comprise silicon oxide. The average particle size is preferably between 1 and 100, more preferably between 3 and 70, and especially preferred between 60 and 30 nm. It has been found that with a sol-gel method in which nanoparticular silicon oxide is added to the sol, a porous anti-reflection layer with a low refraction index and high abrasion resistance can be provided.

Preferably, the barrier layer is applied by flame pyrolysis. It has been found that in this manner a dense layer with a strong barrier effect can be produced in a simply way. Alternatively, other methods are suitable for applying the barrier layer, in particular PVD or CVD methods.

The sol-gel layer is preferably provided as a porous single layered anti-reflection coating and has a refractive index of less than 1.35, preferably less than 1.32, and more preferably less than 1.30.

Preferably, the barrier layer is substantially free of sodium.

The invention also relates to a composite material which comprises a substrate, in particular a glass substrate. Furthermore, the composite material has a porous anti-reflection layer, in particular a porous single layered anti-reflection coating. According to the invention, the composite material comprises at least one barrier layer which is placed between the substrate and the anti-reflection layer.

Such a composite material which surprisingly exhibits a strong environmental resistance for the reasons mentioned above is useful for photo-voltaic applications, in particular in combination with soda-lime glass.

The barrier layer is preferably formed substantially as a silicon oxide layer. The anti-reflection layer is preferably applied by a sol-gel method.

The invention enables to provide a composite material which has a transmittance of at least 85%, preferably at least 90%, and more preferably at least 95% between 450 and 800 nm.

As a substrate of the composite material, preferably a soda-lime glass is used which is available at low cost. Use of other glass types and use of plastic materials is also contemplated.

For example, it is possible with UV radiation blocking layers to protect electronic devices in solar receivers from UV radiation.

In a modification of the invention the porous anti-reflection layer is provided as a hydrophobic layer.

Hydrophobic properties may for example be obtained by adding nanoparticles.

In a preferred embodiment of the invention, a substrate is used which has an amount of sodium oxide of at least 2, preferably 3, and more preferably 10 percent by weight. In particular, low cost soda-lime glasses can be used.

The anti-reflection layer is provided as a wiping resistant layer such that the composite material which is in particularly used as a solar glass can be cleaned mechanically. In particular, the anti-reflection layer is wiping resistant in accordance with DIN 58196-5.

In a preferred embodiment of the invention, the anti-reflection layer has a porosity between 5 and 60, preferably between 20 and 40% (closed porosity).

The sol-gel layer can be applied in a particularly simple way by a dip coating method, but alternatively also by spin coating, flooding, spraying, doctor blading, slot casting, painting or by roll coating.

For an optimum anti-reflective effect, the average pore size of the porous anti-reflection layer may range from 1 to 50, preferably from 2 to 10 nm.

In one embodiment of the invention the barrier layer may comprise a dense sol-gel layer. A sol-gel method also enables to apply dense layers that exhibit a good barrier effect in a particularly simple and cost effective manner.

The thickness of the anti-reflection layer of a preferred embodiment of the invention is between 30 and 500, preferably between 50 and 200, more preferably between 100 and 150 nm.

The composite material according to the invention is in particular suitable for all types of solar applications in which high transmittance in the visible range is desirable, such as photovoltaics, solar collectors, in particular solar receivers, and photobioreactors. The invention is also useful for green houses, for water treatment plants such as for detoxification and disinfection, and for desalination plants.

The invention moreover relates to a method for producing a composite material wherein a substrate, in particular a glass substrate, is coated with at least one anti-reflection layer. According to the invention, at least one barrier layer is applied between the at least one anti-reflection layer and the substrate. Other intermediate layers forming part of the so produced composite material are within the scope of the invention.

Also, it is not imperative in the sense of the invention for the layers to adjoin at defined interfaces. Rather, it is also contemplated to form a gradient layer system, in function of the production method.

In particular, it is contemplated to apply a dense barrier layer substantially comprised of silicon oxide which merges into a porous anti-reflection layer, for example in a PVD or CVD process by varying the process parameters.

A method for applying porous glass layers by a PVD method is known for example from German disclosure DE 10 2005 044 522 “Verfahren zum Aufbringen einer porösen Glasschicht”. The disclosure of this document is incorporated herein by reference.

Alternatively, and preferably, the anti-reflection layer is applied by a sol-gel method.

In a modification of the invention, an organic silicon compound is added to the particular SiO₂ sol, in particular tetramethoxysilane, triethoxymethylsilane, or tetraethoxysilane.

Surprisingly, it has been found that by adding such an organic silicon compound a significantly better mechanical resistance of the anti-reflection layer is obtained.

The organic silicon compound herein is preferably added in a dose such that between 2 and 50%, preferably between 5 and 25%, and more preferably between 7 and 15% of the silicon of the obtained anti-reflection layer originate from the organic silicon compound added.

The temperature for firing the layers is between 400 and 750° C., preferably between 500 and 670° C.

Preferably, the porous sol-gel layer is applied on a glass substrate which is pre-stressed. Pre-stressing is preferably carried out when firing the anti-reflection layer. In this way, no additional method step is required for firing the anti-reflection layer, rather the pre-stressing process may be used for firing the anti-reflection layer.

The invention further relates to a method for applying a preferably porous sol-gel layer wherein at least one sol-gel layer is applied, preferably on a glass substrate, which layer includes a silicon-organic precursor.

According to the invention, hydrolysis and condensation occur in an acid environment.

It has been found that by performing hydrolysis and condensation in particular in a highly acid environment structures are formed which are significantly more adhesive and abrasion resistant than that of known methods for producing anti-reflection layers based on a particular sol and/or a silicon-organic precursor.

In a modification of the invention, an aluminium compound is added to a particular sol so that an aluminium matrix or a matrix partially doped with aluminium is formed which provides a significantly higher mechanical and chemical resistance of the anti-reflection layer.

According to a preferred embodiment of the invention, a sodium blocking layer is applied on the glass as a first layer. In optimal manner, SiO₂ is used as a barrier layer and is applied as thin as possible, for not to impair the optical characteristics more than necessary, but generally other materials having a good Na blocking capability are suitable as well as a barrier layer, e.g. TiO₂, or SnO₂, or Al₂O₃. As a coating method generally any method is suitable that enables to apply homogenous layers over large surfaces, for example CVD methods such as thermal or plasma CVD, or PVD methods such as sputtering. Application of the barrier layer by flame pyrolysis is especially preferred.

The barrier layer presumably prevents or significantly reduces diffusion of sodium into the layer. This, however, mostly reduces abrasion resistance, and generally reduces mechanical strength of the particle based porous SiO₂ coatings.

In order to ensure good mechanical strength, another material may be added to the sol, in particular a metal oxide forming material which acts as a hardener. For example, aluminium may be added as a hardener. This, however, increases the refractive index, decreasing the efficiency of the layers so produced.

In a surprisingly simple way, the mechanical strength of the resulting layer can be increases significantly by adding an organic silicon compound to the particular SiO₂ sol. Organic silicon compounds suitable for this are in particular tetraethoxysilane or triethoxymethylsilane, but other alkoxy silane compounds such as tetramethoxysilane may be used as well. Most preferably, about 10% of the total amount of SiO₂ in the layer originate from the silicon-organic compound, 90% originate from the particular SiO₂ sol.

Hydrolysis and condensation of the silicon-organic precursor are preferably not performed in a neutral or slightly alkaline pH range, but in a highly acid environment. In a highly acid environment, hydrolysis and condensation induce formation of polymeric SiO₂ structures. Thus, there are not two fractions of particles; rather a coating is produced in which the SiO₂ particles are embedded in a polymerically linked SiO₂ matrix. This polymeric SiO₂ matrix seems to provide a particularly adhesive and abrasion resistant coating, though Na diffusion is restricted by an underlying barrier layer.

Although the pores between the individual SiO₂ particles are filled in this manner with polymeric SiO₂, satisfactory refractive indices about 1.31 are still obtained, which allow significant performance improvements of photovoltaic modules or other products for solar applications such as solar receivers or solar collectors, and photobioreactors. Firing of the so produced layers may be performed in a separate tempering step, e.g. at 550° C. for 1 hour. However, it is also possible and will be more advantageous in most cases to perform the firing step during the thermal pre-stressing process. When subjecting these layers to stress tests relevant for a solar module, they show a significantly better long-time stability when compared to conventional layers. In particular, substantially no glass corrosion occurs.

### BRIEF DESCRIPTION OF THE SEVERAL VIEWS OF THE DRAWINGS

The sole FIGURE illustrates an exemplary embodiment of a composite material according to the present disclosure.

### DETAILED DESCRIPTION OF THE INVENTION

Referring to FIGURE, a composite material 1 will be described in detail by means of an exemplary embodiment which is illustrated schematically. The composite material 1 comprises a substrate 2. In this exemplary embodiment this is a soda-lime glass poor in iron.

On substrate 2, a barrier layer 3 substantially comprised of silicon oxide has been applied by a flame pyrolysis method.

Finally, a porous anti-reflection layer 4 is applied on the barrier layer by a sol-gel method.

Surprisingly, the weather resistance of composite material 1 was considerably enhanced by virtue of barrier layer 3 arranged below anti-reflection layer 4.

It will be understood that the invention is not limited to a combination of the features such as described above; rather a person skilled in the art may combine any features, as appropriate.

1-51. (canceled)

52. A substrate with at least one sol-gel layer, wherein at least one barrier layer is provided between said sol-gel layer and said substrate.

53. The substrate with at least one sol-gel layer according to claim 52, wherein said at least one barrier layer has a thickness between 5 and 50 nm.

54. The substrate with at least one sol-gel layer according to claim 52, wherein said at least one sol-gel layer comprises particles having a size between 6 and 30 nm.

55. The substrate with at least one sol-gel layer according to claim 52, wherein said at least one barrier layer is formed as a sodium blocking layer.

56. The substrate with at least one sol-gel layer according to claim 52, wherein said at least one barrier layer includes a metal or semi-metal oxide.

57. The substrate with at least one sol-gel layer according to claim 52, wherein said at least one barrier layer includes SiO₂, TiO₂, SnO₂ or Al₂O₃.

58. The substrate with at least one sol-gel layer according to claim 52, wherein said at least one barrier layer is substantially free of sodium.

59. The substrate with at least one sol-gel layer according to claim 52, wherein said at least one sol-gel layer is provided as an anti-reflection layer.

60. The substrate with at least one sol-gel layer of claim 59, wherein said anti-reflection layer is formed as a porous single layered anti-reflection coating.

61. The substrate with at least one sol-gel layer according to claim 52, wherein said at least one sol-gel layer has a refractive index of less than 1.35.

62. The substrate with at least one sol-gel layer according to claim 52, wherein said at least one sol-gel layer has a refractive index of less than 1.32.

63. The substrate with at least one sol-gel layer according to claim 52, wherein said at least one sol-gel layer has a refractive index of less than 1.30.

64. The substrate with at least one sol-gel layer according to claim 52, wherein said anti-reflection layer has a thickness between 50 and 200 nm.

65. The substrate with at least one sol-gel layer according to claim 52, wherein said substrate comprises a glass poor in iron.

66. A composite material, comprising a glass substrate having at least one porous anti-reflection layer, wherein said composite material comprises at least one barrier layer, said at least one barrier layer being placed between said at least one porous anti-reflection layer and said glass substrate.

67. The composite material according to claim 66, wherein said at least one porous anti-reflection layer is provided as a sol-gel layer.

68. The composite material according to claim 66, wherein said at least one barrier layer includes SiO₂, TiO₂ or SnO₂ or Al₂O₃.

69. The composite material according to claim 66, wherein said at least one barrier layer is applied by a method selected from the group consisting of flame pyrolysis, a PVD method, a CVD method, and a sol-gel method.

70. The composite material according to claim 66, wherein said at least one porous anti-reflection layer includes a metal oxide as a hardener.

71. The composite material according to claim 66, wherein said at least one porous anti-reflection layer has a refractive index of less than 1.35.

72. The composite material according to claim 66, wherein said composite material has a transmittance of at least 85% between 450 and 800 nm.

73. The composite material according to claim 66, wherein said at least one porous anti-reflection layer is provided as a hydrophobic layer.

74. The composite material according to claim 66, wherein said substrate has an amount of sodium oxide of at least 2 percent by weight.

75. The composite material according to claim 66, wherein said at least one porous anti-reflection layer has a porosity from 5 to 60%.

76. The composite material according to claim 66, wherein said at least one porous anti-reflection layer has average pore size from 1 to 50 nm.

77. The composite material according to claim 66, wherein said at least one porous anti-reflection layer has average pore size from 2 to 10 nm.

78. A method for producing a composite material, comprising:
coating a glass substrate with at least one anti-reflection layer; and
applying at least one barrier layer said at least one anti-reflection layer and said substrate.

79. The method for producing a composite material according to claim 78, wherein said at least one anti-reflection layer is provided as a porous single layered anti-reflection coating.
